(19) United States
(12) Patent Application Publication
(10) Pub. No.: US 2006/0268907 A1
(43) Pub. Date: Nov. 30, 2006

(54) System for enabling heterogeneous communication systems to cooperate in providing communication services and method therefor

(75) Inventors: Sang-Do Lee, Suwon-si (KR); Sung-Won Lee, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/442,780

(22) Filed: May 30, 2006

(30) Foreign Application Priority Data
May 30, 2005 (KR) 45651-2005

(51) Int. Cl. H04L 12/56

(52) U.S. Cl. 370/401; 370/465

(57) ABSTRACT

Provided is a method for enabling a first communications system for providing first communication services to cooperate with a second communications system for providing second communication services for providing complementary communication services in a network including the first and second communications system, which includes the steps of detecting the necessity of providing the second communication services for a mobile communication terminal presently receiving the first communication services; and notifying the second communications system of the necessity of providing the second communication services so as to cause the second communications system to establish a communication link for the mobile communication terminal to receive the second communication services.

### PRIORITY

This application claims priority under 35 U.S.C. §119 to an application entitled “Method for Service Interworking Between Heterogeneous Systems” filed in the Korean Intellectual Property Office on May 30, 2005 and assigned Serial No. 2005-45651, the contents of which are incorporated herein by reference.

### BACKGROUND OF THE INVENTION

1. Field of the Invention

The present invention relates generally to a communication system, and more particularly to a system for enabling heterogeneous communication systems to cooperate in providing communication services and method therefor.

2. Description of the Related Art

Presently communication systems are undergoing rapid development toward next generation communication systems employing new communication technologies. Accordingly, provision of communication services requires using the next generation communication systems, rather than the conventional systems. But, until the communication services employing the next generation communication system become more stable and marketable, employing both the next generation communication system and the conventional communication system remains essential for complementary communication services.

For example, if the conventional communication system is based on Code Division Multiple Access 2000 1×EVDO (CDMA 2000 1× Evolution Data Only), and the next generation communication system is based on broadband wireless access (BWA), it is necessary to employ both CDMA 2000 1×EVDO system and BWA system for providing complementary communication services until BWA becomes more stable and marketable. This calls for a technological solution for enabling the conventional communication system and the next generation communication systems to cooperate for providing complementary communication services.

### SUMMARY OF THE INVENTION

It is an object of the present invention to provide a system and method for enabling heterogeneous communication systems to cooperate for providing complementary communication services.

According to an aspect of the present invention, a method for enabling a first communication system for providing first communication services to cooperate with a second communication system for providing second communication services in providing complementary communication services in a network including the first and second communication system, includes detecting the necessity of providing the second communication services for a mobile communication terminal presently receiving the first communication services; and notifying the second communication system of the necessity of providing the second communication services for causing the second communication system to establish a communication link for the mobile communication terminal to receive the second communication services.

According to still another aspect of the present invention, a method for enabling heterogeneous communication systems to cooperate for providing communication services, includes detecting the necessity of providing second communication services for a mobile communication terminal receiving first communication services from a first communication system through a first communication link; causing the first communication system to ask a second communication system for authentication of the mobile communication terminal; causing the second communication system to notify the first communication system of permission for providing second communication services after authenticating the mobile communication terminal; causing the first communication system to notify the mobile communication terminal of the permission for the second communication system to provide the second communication services; and causing the mobile communication terminal to establish a second communication link with the second communication system to provide the second communication services for the terminal.

According to still yet another aspect of the present invention, a system for enabling heterogeneous communication systems to cooperate for providing complementary communication services, includes a mobile communication terminal capable of working both at first communication service mode and second communication service mode; a first communication system for providing first communication services; and a second communication system for providing first communication services, wherein the first communication system detects the necessity for providing the second communication services for the mobile communication terminal presently receiving the first communication services, and notifies the second communication system of the necessity of providing the second communication services so as to cause the second communication system to establish a communication link for the mobile communication terminal to receive the second communication services.

### BRIEF DESCRIPTION OF THE DRAWINGS

The above and other objects, features and advantages of the present invention will become more apparent from the following detailed description when taken in conjunction with the accompanying drawing in which:

FIG. 1 is a block diagram schematically illustrating a network designed to enable CDMA 2000 1×EVDO and BWA systems to cooperate in providing complementary communication services according to the present invention;

FIG. 2 is a block diagram schematically illustrating the internal structure of CAG (117) as shown in FIG. 1;

FIG. 3 is a flowchart for illustrating a process of a dual mode communication terminal for accessing a network as shown in FIG. 1 according to the present invention; and

FIG. 4 is a schematic diagram for illustrating the process of providing BWA communication services to a dual mode communication terminal connected to CDMA 2000 1×EVDO communication system according to the present invention.

### DETAILED DESCRIPTION OF THE PREFERRED EMBODIMENT

Preferred embodiments of the present invention will be described herein below with reference to the accompanying drawings. In the drawings, the same or similar elements are denoted by the same reference numerals even though they are depicted in different drawings. In the following description, well-known functions or constructions are not described in detail since they would obscure the invention in unnecessary detail.

In order to more specifically describe the inventive system and method for enabling heterogeneous communication systems to cooperate for providing complementary communication services for a mobile communication terminal, the conventional communication system is selected based on Code Division Multiple Access 2000 1×EVDO (CDMA 2000 1×EVDO), and the next generation communication system on Broadband Wireless Access (BWA).

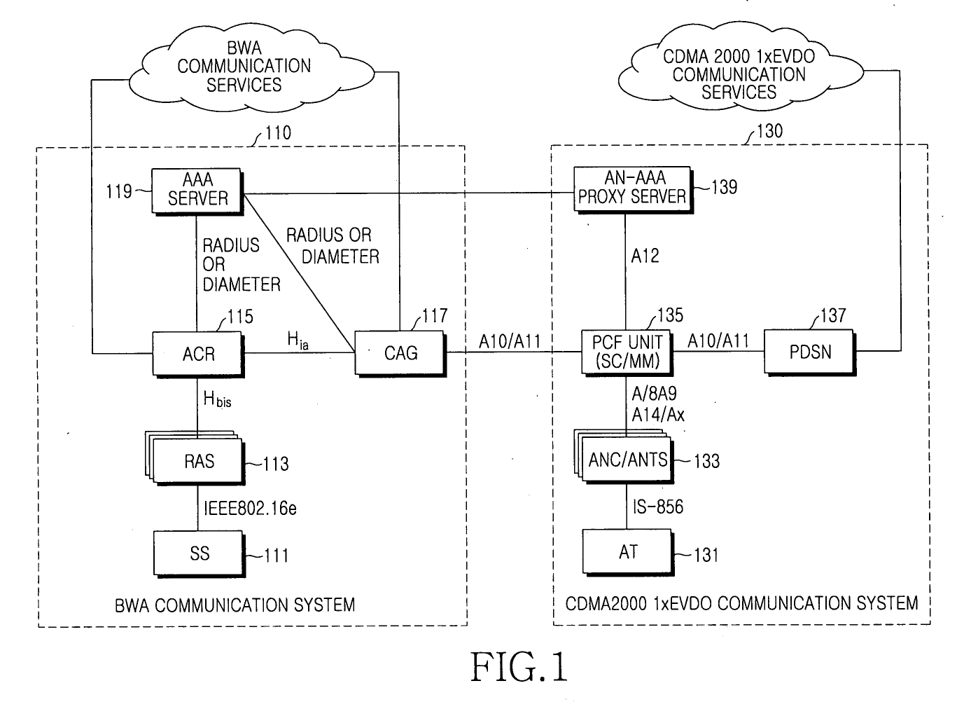

Referring to FIG. 1, there is shown a network designed to enable BWA system 110 and CDMA 2000 1×EVDO system 130 to cooperate in providing complementary communication services according to the present invention. For simplicity, a communication system presently providing communication services for a mobile communication terminal is referred to as “home communication system”, and another communication system where the mobile communication terminal visits as “visit communication system”. In FIG. 1, if it is assumed that a mobile communication terminal presently connected to the BWA communication system 110 visits CDMA 2000 1×EVDO system 130, where the home communication system of the mobile communication terminal will be the BWA communication system 110, and the visit communication system will be the CDMA 2000 1×EVDO system 130. In order to receive complementary communication services by the cooperation of the BWA and CDMA 2000 1×EVDO systems 110 and 130, respectively, the mobile communication terminal can work at dual mode, i.e., both at BWA communication mode and CDMA 2000 1×EVDO communication mode.

The BWA communication system 110 includes a subscriber station (SS) 111, a radio access station (RAS) 113, an access control router (ACR) 115, a cellular access gateway (CAG) 117, and an authorization, authentication, and accounting (AAA) server 119. It is noted that the dual mode terminal as described above herein is named SS 111 when working at the BWA communication mode.

The ACR 115 performs the authentication of the SS 111, the treatment of medium access control (MAC) protocol, allocation of Internet protocol (IP) addresses, and the routing function. The CAG 117 performs the authentication of the SS 111 accessing the CDMA 2000 1×EVDO communication system 130, the treatment of point-to-point protocol (“PPP”) session, allocation of IP addresses, routing, and provision of BWA communication services for the SS 111. The AAA server 119 performs the authentication, authorization and accounting of the SSS 111.

The CDMA 2000 1×EVDO communication system 130 includes an access terminal (AT) 131, an access network controller/access network transmission system (ANC ANTS) 133, a packet control function (“PCF”) unit 135 for performing session control/mobility management (SC/MM), a packet data serving node (hereinafter referred to as “PDSN”) 137, and an access network (AN)-AAA proxy server 139. In this case, it is noted that the dual mode communication terminal is called AT 131 working at the CDMA 2000 1×EVDO communication mode.

The PCF (SC/MM) unit 135 manages the packet data session between the ANC/ANTS 133 and the PDSN 137 or the CAG 117, delivering a user traffic. The PDSN 137 delivers CDMA 2000 1×EVDO communication services to a mobile communication terminal connected to the CDMA 2000 1×EVDO communication system 130. The AN-AAA proxy server 139 delivers the signaling messages relating to the authentication, authorization and accounting between the AT 131 connected to the CDMA 2000 1×EVDO communication system 130 and the AAA server 119.

Hereinafter will be described the cooperation of the BWA and CDMA 2000 1×EVDO communication systems 110 and 130, respectively, for providing complementary communication services for the mobile communication terminal.

First, accessing the BWA communication system 110, the SS 111 may receive BWA communication services through the RAS 113 and ACR 115.

Second, accessing the CDMA 2000 1×EVDO communication system 130, the AT 131 can receive BWA communication services through the CAG 117 connected to the PCF (SC/MM) unit 135 to the ANC/ANTS 133.

Third, accessing the BWA communication system 110, the SS 111 may receive CDMA 2000 1×EVDO communication services through the CAG 117 connected to the ACR 115 to RAS 113.

Fourth, accessing the CDMA 2000 1×EVDO communication system 130, the AT 131 may receive CDMA 2000 1×EVDO communication services through PDSN 137 connected to the PCF (SC/MM) unit to the ANC/ANTS 133. The following Table 1 shows the interfaces between the units constituting the network shown in FIG. 1.

TABLE 1

| Interface | Description |
|---|---|
| A8 | Treating a user traffic transferred between ANC and |
| | PCF unit |
| A9 | Defining signaling process such as transmission, ending, |
| | and reception of a packet call between ANC and PCF unit |
| A10 | Treating a user traffic transferred between PCF unit |
| | and PDSN or CAG |
| A11 | Defining signaling process such as transmission and |
| | ending of a packet call between PCF unit and PDSN or CAG |
| A12 | Authenticating a user and mobile communication terminal |
| | between SC/MM server and AN-AAA proxy server, and |
| | defining the signaling process for delivering Mobile Node |
| | Identifier (MNID) |
| H_{bis} | Transferring signaling and a user traffic between ACR |
| | and RAS |
| Hᵢₐ | Transferring session information and establishing tunnel |
| | either between different ACRs or between ACR and CAG |
| IEEE | Defining wireless access specification between the |
| 802.16e | mobile terminal and RAS, and protocol governing the |
| | signaling process, packet transferring process and MAC |
| | relating to authentication and connection of the mobile |
| | terminal accessing a BWA system |
| IS-856 | Defining radio access specification between the mobile |
| | terminal and ANTS, and protocol governing the signaling |
| | process, packet transfer process and MAC relating to |
| | transmission/reception of a CDMA 2000 1 × EVDO |
| | packet call |

In order to enable the BWA and CDMA 2000 1×EVDO communication systems 110 and 130 to cooperate for providing complementary communication services, the dual mode mobile communication terminal and CAG 117 require the following essential functions.

First, the dual mode terminal requires the particular functions as follows:

1. To select and access the optimum one of the BWA and CDMA 2000 1×EVDO communication systems;

2. To generate a network access identifier (NAI) delivered to the PCF (SC/MM) unit 135 during the authentication of challenge handshake authentication protocol (CHAP) upon accessing the CDMA 2000 1×EVDO communication system. In this case, the NAI includes the identifier by which the BWA communication system can identify the dual mode terminal; and

3. To perform establishment of the PPP session and service authorization with the CAG 117 and receive an allocation of an IP address after transmitting a CDMA 2000 1×EVDO call when the authentication of CHAP is successfully completed by accessing the CDMA 2000 1×EVDO communication system 130.

Secondly, the CAG 117 requires the particular functions as follows:

1. To treat A10/A11 interfaces with the PCF (SC/MM) unit 135;

2. To dynamically generate or maintain security association (SA) with the PCF (SC/MM) unit 135;

3. To generate and maintain the PPP session for the dual mode terminal connected to the CDMA 2000 1×EVDO communication system 130;

4. To perform the service authorization between the AAA server 119 and the dual mode terminal connected to the CDMA 2000 1×EVDO communication system 130;

5. To allocate an IP address for the dual mode terminal accessing the CDMA 2000 1×EVDO communication system 130 according to dynamic host control protocol (DHCP) or IP control protocol (hereinafter referred to as “IPCP”), and then to allocate the static IP address received together with the service authorization result from the AAA server 119 to the dual mode terminal;

6. To support a communication terminal receiving mobile IP services by including foreign agent (FA) function;

7. To perform PPP framing delivered through the A10 interface to the PCF(SC/MM) unit 135 for a user traffic transferred to the dual mode terminal connected to the CDMA 2000 1×EVDO communication system 130;

8. To perform IP routing for user traffic received from the PCF (SC/MM) unit 135 through the A10 interface;

9. To collect the accounting information of the dual mode terminal accessing the CDMA 2000 1×EVDO communication system 130 delivered to the AAA server 119; and

10. To end the PPP session of the dual mode terminal upon requesting of the AAA server 119.

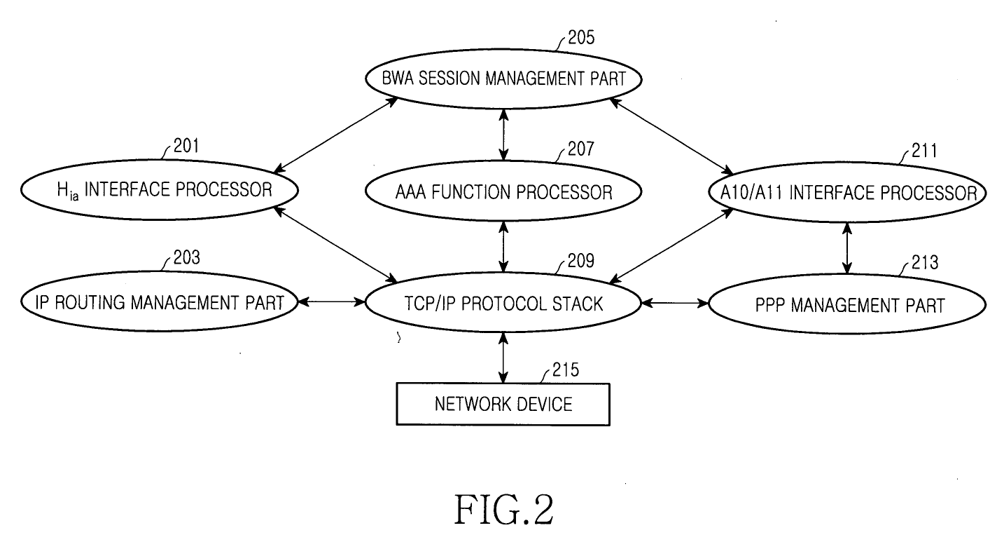

Describing the internal structure of the CAG 117 in connection with FIG. 2, the CAG 117 generally includes a session management part, an interface processor, a traffic processor, and a network device.

The session management part includes a BWA session management part 205 for managing the BWA session of the AT 131, and a PPP management part 213 for managing the PPP session and PPP framing. The session management part manages the session of the mobile communication terminal connected to the BWA or CDMA 2000 1×EVDO communication system 110 or 130 by using the access information of the mobile communication terminal.

The interface processor includes Hᵢₙ interface processor 201 for processing the Hᵢₐ interface between the ACR 115 and CAG 117, and A10/A11 interface processor 211 for processing the A10/A11 interface between the CAG 117 and PCF (SC/MM) unit 135. The Hᵢₐ interface processor 201 processes the signaling messages transferred between the ACR 115 and CAG 117, and the user traffic transferred through a tunnel between the ACR 115 and CAG 117.

The traffic processor includes an IP routing management part 203 for managing IP routing, an AAA function processor 207 for processing AAA signaling messages of authentication, authorization and accounting, and a transmission control protocol (TCP)/IP protocol stack 209.

The network device 215 transfers the signaling messages received from an external unit like the ACR 115 to the interface processor, and also from the interface processor to an external unit such as the ACR 115.

Describing the operation of the CAG 117, if the dual mode terminal accesses the BWA communication system 110, the Hᵢₐ signaling messages transmitted from the ACR 115 are delivered through the network device 215 and TCP/IP protocol stack 209 to the Hᵢₐ interface processor 201, which processes various signaling messages defined by the Hᵢₐ interface. On the contrary, the signaling messages transmitted from the Hᵢₐ interface processor 201 of the CAG 117 are delivered through the TCP/IP protocol stack 209 and network device 215 to the ACR 115.

Alternatively, if the dual mode terminal accesses the CDMA 2000 1×EVDO communication system 130, the A11 signaling messages transferred from the PCF (SC/MM) unit 135 are delivered the network device 215 and TCP/IP protocol stack 209 to the A10/A11 interface processor 211. On the contrary, the A11 signaling messages transmitted from the A10/A11 interface processor 211 of the CAG 117 are delivered through the TCP/IP protocol stack 209 and network device 215 to PCF (SC/MM) unit 135. In addition, the signaling messages between the CAG 117 and AAA server 119, for example, those according to the remote authentication dial-in user service (“RADIUS”) protocol and DIAMETER protocol, are delivered through the AAA function processor 207, TCP/IP protocol stack 209 and network device 215.

In addition, if a dual mode terminal connected to the BWA communication system 110 transmits an IP packet, it is delivered through the network device 215 and TCP/IP protocol stack 209 of the CAG 117 to the IP routing management part 203 to another dual mode communication terminal connected to an external communication system different from the BWA communication system connected with the former dual mode communication terminal, for example, the CDMA 2000 1×EVDO communication system 130, or other dual mode terminals connected to the BWA communication system 110. The same procedure applies when other dual mode terminals accessing the CDMA 2000 1×EVDO communication system 130 or the BWA communication system 110 transmit an IP packet.

Alternatively, if the dual mode terminal accessing the CDMA 2000 1×EVDO communication system 130 transmits a PPP frame, it is delivered through the network device 215 and TCP/IP protocol stack 209 of the CAG 117 to the A10/A10 interface processor 211, which removes the IP header and GRE (Generic Record Encapsulation) header from the PPP frame delivered to the PPP management part 213, which in turn decodes the PPP frame to generate the IP packet delivered to the IP routing management part 203. Then the IP routing management part 203 delivers the IP packet through the TCP/IP protocol stack 209 and network device 215 to an external communication system or another dual mode terminal according to the result of a routing procedure for obtaining packet transfer case by referring to a routing table, for example, one prescribed in the system.

Alternatively, if a dual mode terminal connected to an external communication system or another dual mode terminal connected to the same BWA communication system 110 transmits an IP packet to a dual mode terminal connected to the CDMA 2000 1×EVDO communication system 130, the IP packet is delivered through the network device 215 and TCP/IP protocol stack 209 of the CAG 117 to the PPP management part 213, which then transforms the IP packet into a PPP frame delivered to the A10/A11 interface processor 211. Then the A10/A11 interface processor 211 generates the GRE header for the PPP frame delivered through the TCP/IP protocol stack 209 and network device 215 to the PCF (SC/MM) unit 135. Thus, the PPP frame is transferred to the dual mode terminal connected to the CDMA 2000 1×EVDO communication system 130.

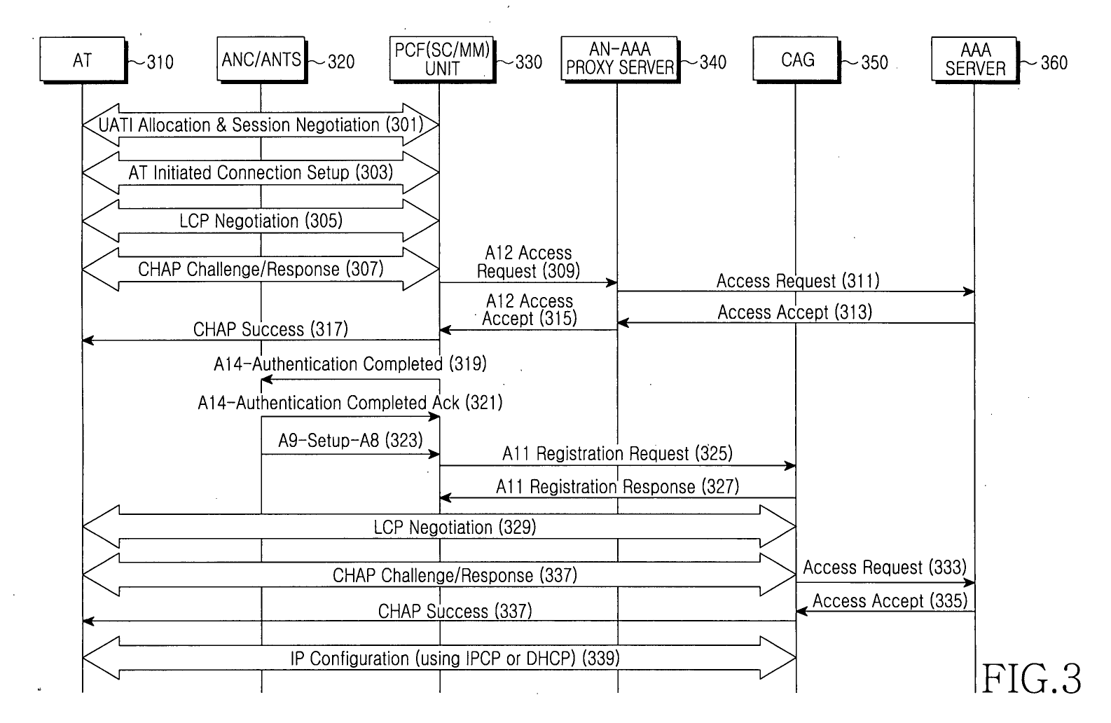

Referring to FIG. 3, there is shown the process of a dual mode terminal placed in the service region of the CDMA 2000 1×EVDO communication system 130 to access the system. In this case, the dual mode terminal firstly accesses the CDMA 2000 1×EVDO communication system 130 after power-on, and then the BWA communication system. For convenience's sake, the service region of the CDMA 2000 1×EVDO communication system 130 is referred to as “CDMA 2000 1×EVDO communication service region”.

The dual mode terminal placed in the CDMA 2000 1×EVDO communication service region, i.e., AT 310 powered on, searches the CDMA 2000 1×EVDO communication system for the ANC/ANTS to which it belongs.

Upon detecting the ANC/ANTS, the AT 310 accesses the PCF (SC/MM) unit 330 of the CDMA 2000 1×EVDO communication system through the ANC/ANTS 320. The AT 310 performs unicast access terminal identifier (“UATI”) allocation and CDMA 2000 1×EVDO session negotiation with the PCF (SC/MM) unit 330 (Step 301).

Completing the UATI allocation and CDMA 2000 1×EVDO session negotiation, the AT 310 originates a CDMA 2000 1×EVDO packet call to receive an allocation of wireless resources from the CDMA 2000 1×EVDO system. Namely, the AT 310 performs AT initiated connection setup with the PCF (SC/MM) unit 330 (Step 303). Then, the AT 310 performs link control protocol (LCP) negotiation, i.e., link hierarchical negotiation, according to the PPP protocol, with the PCF (SC/MM) unit 330 (Step 305).

Following the LCP negotiation, the PCF (SC/MM) unit 330 sends a CHAP challenge value to the AT 310. In this case, the challenge value is a random value generated by the authentication server, used by the authenticated terminal to calculate a response value transmitted to the authentication server (Step 307). Meanwhile, the AT 310 generates NAI during the CHAP authentication process, transmitted to the PCF (SC/MM) unit 330. The NAI generated by the AT 310 represents the identifier for distinguishing the AT 310.

Thereafter receiving the CHAP response value from the AT 310, the PCF (SC/MM) unit 330 generates A12 access request message delivered to the AN-AAA proxy server 340 (Step 309). Then the AN-AAA proxy server 340 analyzes the NAI contained in the A12 access request message to obtain the information of the AAA server 360 to allow access of the AT 310. Thereafter, the AN-AAA proxy server 340 generates an access request message transmitted to the AAA server 360 (Step 311).

Upon receiving the access request message, the AAA server 360 analyzes the information of the NAI, CHAP challenge/response values, etc. contained in the access request message to perform the access authentication. Then completing successfully the access authentication, the AAA server 360 transmits an access accept message in response to the access request message to the AN-AAA proxy server 340 (Step 313).

Receiving the access accept message from the AAA server 360, the AN-AAA proxy server 340 generates A12 access accept message transmitted to the PCF (SC/MM) unit 330 (Step 315), which in turn generates a CHAP success message delivered to the AT 310 (Step 317). Namely, the PCF (SC/MM) unit 330 notifies the AT 310 of the successful authentication by the CHAP success message.

After transmitting the CHAP success message to the AT 310, the PCF(SC/MM) unit 330 generates A14 authentication completed message transferred to the ANC/ANTS 320 (Step 319), which in turn transmits A14 authentication completed acknowledge (ACK) message generated in response to the A14 authentication completed message to the PCF(SC/MM) unit 330 (Step 321). In this case, the message generated by the ANC/ANTS 320 in response to the A14 authentication completed message from the PCF(SC/MM) unit 330 may be A14 authentication completed acknowledge (ACK) message or A14 authentication completed negative-acknowledge (NACK) message, whereby the AT 310 is notified whether the access authentication has succeeded or failed.

Completing the access authentication of the AT 310, the ANC/ANTS 320 generates A9-setup-A8 message delivered to the PCF (SC/MM) unit 330 to request the setup of a CDMA 2000 1×EVDO packet call (Step 323). In this case, the A9-setup-A8 message represents the signaling message to set up A8 interface, i.e., GRE tunnel between the PCF (SC/MM) unit 330 and the ANC/ANTS 320.

Upon receiving the A9-setup-A8 message, the PCF (SC/MM) unit 330 generates A11 registration request message delivered to the CAG 350 (Step 325). In this case, the A11 registration request message represents the signaling message to set up A10 interface, i.e., GRE tunnel between the PCF (SC/MM) unit 330 and CAG 350. Upon receiving the All registration request message, the CAG 350 recognizes that the AT 310 is attempting to access the BWA communication system through the CDMA 2000 1×EVDO communication system.

Then the CAG 350 transmits A11 registration response message generated in response to the A11 registration request message to the PCF (SC/MM) unit 330. Namely, the CAG 350 allows the setup of GRE, whereby the GRE tunnel is formed between the PCF (SC/MM) unit 330 and the CAG 350 (Step 327).

Following setting up the GRE tunnel with the PCF (SC/MM) unit 330, the CAG 350 performs LCP negotiation with the AT 310 (Step 329). Then, the CAG 350 transfers the CHAP challenge value to the AT 310, which in turn transmits the CHAP response value to the CAG 350 (Step 337). In this case, the AT 310 generates NAI delivered to the CAG 350 during the CHAP authentication.

Receiving the CHAP response value from the AT 310, the CAG 350 analyzes the NAI to locate the AAA server 360 to which the AT 310 belongs. The CAG 350 generates an access request message delivered to the AAA server 360 (Step 333).

Then the AAA server 360 analyzes the information of the NAI and CHAP challenge/response values contained in the access request message to perform service authentication. Completing the service authentication, the AAA server 360 transmits an access accept message generated in response to the access request message to the CAG 350 (Step 335). Upon receiving the access accept message, the CAG 350 generates a CHAP success message delivered to the AT 310 (Step 337).

Completing successfully the CHAP authentication, the CAG 350 and the AT 310 performs IP configuration for a communication channel between them (Step 339). Namely, the CAG 350 allocates an IP address to the AT 310 according to the IP address allocation process by using Dynamic Host Control Protocol (DHCP) or IPCP.

Thus, the BWA communication system can provide BWA communication services for a dual mode terminal connected to the CDMA 2000 1×EVDO communication system. Although the previous description in connection with FIG. 3 relates the BWA communication services provided for the dual mode terminal connected to the CDMA 2000 1×EVDO communication system, the present invention shall not be limited to this case.

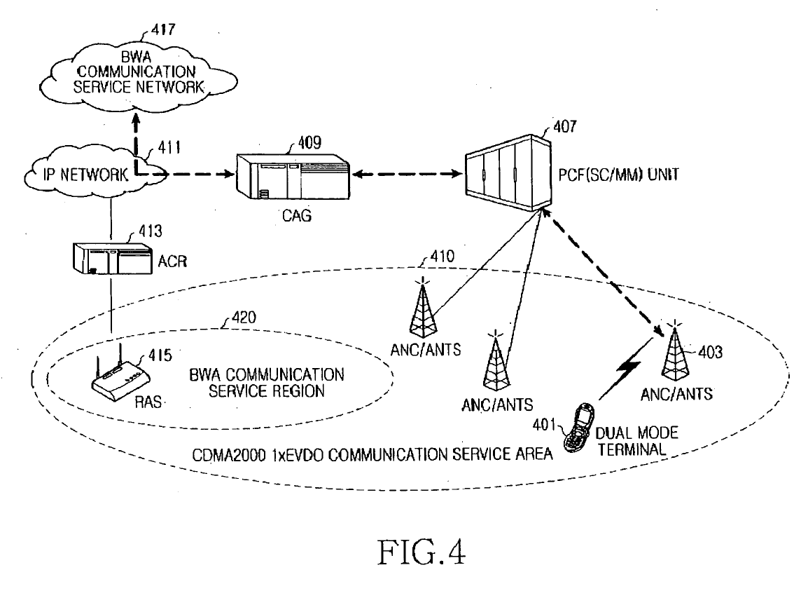

Hereinafter in connection with FIG. 4 is described the process of providing the BWA communication services for the dual mode terminal connected to the CDMA 2000 1×EVDO communication system according to the present invention. Firstly, described is the server RAS 415 placed in the BWA communication service region 420 that transmits a packet to a dual mode terminal 401. The packet transmitted from the RAS 415 is delivered through the ACR 413 and IP network 411 to the CAG 409 that has allocated an IP address to the dual mode terminal 401. Then the CAG 409 transfers the packet to the PCF (SC/MM) unit 407 of the CDMA 2000 1×EVDO communication service region 410 accessed by the dual mode terminal 401. Consequently, the packet received by the PCF (SC/MM) unit 407 from the BWA communication service region 420 through the CAG 409 is transferred through the base station ANC/ANTS 403 to the dual mode terminal 401.

Secondly, described is a dual mode terminal 401 placed in the CDMA 2000 1×EVDO communication service region 410 that transmits a packet to the BWA communication service region 420. As shown in FIG. 4, the packet transmitted from the dual mode terminal 401 is delivered through the ANC/ANTS 403 of the CDMA 2000 1×EVDO communication service region 410 to the PCF (SC/MM) unit 407, which in turn delivers the packet to the CAG 409 that has allocated an IP address to the dual mode terminal 401. Then, the CAG 409 delivers the packet through the IP network 411 and ACR 413 to the server RAS 415 placed in the BWA communication service region 420. The packet transfer between the RAS 415 and CAG 409 is achieved by means of IP routing or IP switching. Also the packet transfer between the CAG 409 and the PCF (SC/MM) unit 407 is achieved by means of GRE tunnel.

As described above, the present invention enables heterogeneous communication systems to cooperate for providing complementary communication services for the dual mode communication terminals. Particularly, the invention enables the BWA and CDMA 2000 1×EVDO communication systems to cooperate for providing complementary communication services, such that, if a dual mode communication terminal already connected to the BWA communication system moves to CDMA 2000 1×EVDO communication system, it may continuously receive the BWA communication services, or vice versa.

While the invention has been shown and described with reference to a certain preferred embodiment thereof, it will be understood by those skilled in the art that various changes in form and details may be made therein without departing from the spirit and scope of the invention.

What is claimed is:

1. In a network including a first communication system for providing a first communication service and a second communication system for providing a second communication service, a method for enabling the first communication system to cooperate with the second communication system for providing complementary communication services, comprising:
detecting a necessity of providing the second communication service for a terminal presently receiving the first communication service; and
notifying the second communication system of the necessity of providing the second communication service thereby causing the second communication system to establish a communication link for the terminal to receive the second communication service.

2. The method of claim 1, wherein the communication link is based on Internet protocol (IP).

3. A system for enabling heterogeneous communication systems to cooperate for providing complementary communication services, comprising:
a terminal capable of working both at first communication service mode and at second communication service mode;
a first communication system for providing a first communication service; and
a second communication system for providing a second communication service,
wherein the first communication system detects a necessity of providing the second communication service for the terminal presently receiving the first communication service, and notifies the second communication system of the necessity of providing the second communication service thereby causing the second communication system to establish a communication link for the terminal to receive the second communication service.

4. The system of claim 3, wherein the second communications system includes a cellular access gateway for providing the second communication service for the terminal.

5. The system of claim 4, wherein the cellular access gateway includes a session management part for managing the session of the terminal connected to at least one of the first and second communication systems by using the access information of the terminal.

6. The system of claim 5, wherein the session management part includes:
a second communication system session management part for managing the session of the terminal connected to the second communication system; and
a point-to-point protocol (PPP) management part for managing PPP session and PPP framing.

7. The system of claim 4, wherein the cellular access gateway includes an interface processor both for interfacing the units constituting the first and second communication system and for treating user traffic between the units.

8. The system of claim 4, wherein if the communication link is based on Internet protocol (IP), the cellular access gateway includes a traffic processor for managing IP routing.

9. The system of claim 3, wherein the second communication system includes an access control router (ACR) for performing the authentication of the terminal accessing the second communication system, treatment of medium access control protocol, allocation of IP addresses, and routing function.

10. The system of claim 3, wherein the second communication system includes an authorization and authentication and accounting (AAA) server for performing the authorization, authentication and accounting for the terminal.

11. The system claim 3, wherein the first communication system includes a packet control function (PCF) unit both for managing packet data session with the second communication system and for delivering a user traffic.

12. The system of claim 3, wherein the first communication system includes an access network/authorization and authentication and accounting proxy server (AN-AAA proxy server) for processing signaling messages relating to the authentication, authorization and accounting of the terminal receiving the second communication services.

13. The system of claim 3, wherein the first communication system is based on code division multiple access 2000 1×EVDO (CDMA 2000 1×Evolution Data Only) scheme, and the second communication system on broadband wireless access (BWA) scheme.

14. The method of claim 1, wherein the first communication system is CDMA 2000 1×EVDO scheme, and the second communication system on BWA scheme.

15. A method for enabling heterogeneous communication systems to cooperate to provide complementary communication services, comprising:
detecting a necessity of providing second communication services for a terminal receiving first communication services from a first communication system through a first communication link;
causing the first communication system to ask a second communication system for authentication of the terminal;
causing the second communication system to notify the first communication system of permission of providing second communication services after authenticating the terminal;
causing the first communication system to notify the terminal of the permission of the second communication system to provide the second communication services; and
causing the terminal to establish a second communication link with the second communication system to provide the second communication services for the terminal.

16. The method of claim 15, wherein the second communication link is based on IP.

17. The method of claim 15, wherein the first communication system is CDMA 2000 1×EVDO, and the second communication system on BWA.
